(19) United States
(12) Patent Application Publication
(10) Pub. No.: US 2011/0305899 A1
(43) Pub. Date: Dec. 15, 2011

(54) METHOD FOR PRODUCING A REFLECTION-REDUCED PANE

(76) Inventors: Marcus Neander, Eschweiler (DE); David Janssen, Toenisvorst (DE)

(21) Appl. No.: 13/203,605

(22) PCT Filed: May 11, 2010
(86) PCT No.: PCT/EP2010/056433

§ 371 Date: Aug. 26, 2011

(30) Foreign Application Priority Data
May 13, 2009 (DE) 102009025788.8

(51) Int. Cl. G02B 1/11; G02B 1/12; B32B 17/00; C03C 15/00; C03B 27/04

(52) U.S. Cl. 428/336; 65/31; 428/410; 428/428; 428/337

(57) ABSTRACT

Methods for manufacturing a pane are described. The manufactured pane can be a reflection-reducing pane having a variety of transmission capacities and refractive indexes. Such reflection-reducing panes can be used in buildings, vehicles and/or photovoltaic glazing.

The invention relates to a method for producing a reflection-reduced pane, a pane produced using the method according to the invention, and its use.

In addition to the high optical transparency desired in many cases, many panes also have strong light reflections. When light strikes an interface between media with different refractive indices, part of the incident light is reflected. Depending on the light source, wavelength, and the angle of incidence, these reflections can be significant. For example, reflections of sunlight on buildings or preceding vehicles can blind other road users. Light reflections are also usually undesirable in photovoltaics since they reduce the amount of light on the surface of photocells. With the reduced amount of light, the efficiency of the solar cell is also reduced in many cases.

Basically, many methods are applied in practice to reduce the reflection of panes. The reflection reduction of panes is based in many cases on the creation of a porous, structured layer on the glass surface. This porous structured layer can be created by etching with an appropriate acid or base. Another possibility is the creation of a porous SiO₂ layer by deposition of SiO₂ on the glass surface, for example, in a sol-gel process. In principle, combinations of the two processes of etching and deposition are also possible.

Because of the mechanical stability of glass, the methods for reflection reduction are usually not possible until after the tempering and bending processes. Thus, usually only customized pane segments and, consequently, a limited number of panes can be etched at the same time.

U.S. Pat. No. 2,486,431 A discloses a method for creating a low-glare glass surface. The glass surface is etched with an H₂SiF₆ solution. Depending on the duration of the etching process, the glass surface is removed in varying degrees and, thus, the optical properties of the surface are adapted and varied.

DE 822 714 B discloses a method for producing a reflection-reducing film on the surface of a glass object. For this, the glass object is dipped into a solution of H₂SiF₆ and colloidally dissolved SiO₂. Depending on the F⁻and SiO₂ concentration, the surface of the pane is removed (etched) and/or built up.

U.S. Pat. No. 4,019,884 A discloses a method for producing a reflection-reducing layer on a glass substrate. The method includes heating at a temperature of 630° C. to 660° C. The glass is then etched in aqueous hydrofluoric acid.

DE 196 42 419 A1 discloses a method for producing an antireflection coating. In the method, an organic silicon compound is applied to the glass surface in a sol-gel process. A hydrophilic, colloidally dissolved polymer or a solvent are preferably added as a catalyst.

DE 199 18 811 A1 discloses a tempered safety glass with a smudge-proof, porous SiO₂ antireflective layer. The production of the safety glass is carried out in a first step by coating the glass with a colloidally dispersed solution. The glass of the coated pane is heated to at least 600° C. and then thermally quenched.

The object of the invention is to provide a method for etching and tempering panes that enables time and cost effective etching of large-area panes before the tempering process.

The object of the present invention is accomplished according to the invention by a method for producing a reflection reduced pane, a pane obtained with the method, and its use according to the independent claims 1, 7, and 14. Preferred embodiments emerge from the subclaims.

The method for producing a reflection-reduced pane comprises in a first step the etching of a pane. The pane preferably contains glass, particularly preferably flat glass (float glass), quartz glass, borosilicate glass, and/or soda lime glass.

In the context of the invention, “etching” includes both the treatment of the surface of the pane with an acid and with a basic solution. These two steps can even occur one after another in any order. After etching or in the case of different etching solutions, the pane is washed and/or cleaned preferably with deionized water. All (multiple) areas of the pane as well as only one area of the pane can be etched.

The etched pane is then heated to a temperature of 500° C., to 800° C. Rapid cooling (quenching) of the heated, etched pane follows the heating. In this process, the surface of the pane cools faster than the core zone, such that tensions develop in the glass. These increase the stability and the strength of the glass. Together, heating and rapid cooling constitute the tempering process of the method according to the invention. The pane is cooled preferably to a temperature of 25° C. to 70° C., particularly preferably 35° C. to 50° C. within 30 s to 150 s by cold air jet.

The etching takes place preferably by applying and/or spraying a solution of an acid and/or base on the surface of the pane.

The etching takes place preferably by dipping the pane in a solution of an acid and/or base.

The pane is preferably etched with HF, H₂SiF₆, (SiO₂)m*nH₂O (m, n=0, 1, 2, 3, . . . ), HCl, H₂SO₄, H₃PO₄, HNO₃, CF₃COOH, CCl₃COOH, HCOOH, CH₃COOH, NaOH, KOH, Ca(OH)₂, and/or mixtures thereof.

The pane is preferably treated in a first step with an HF or NaOH solution. The pane is then washed one or a plurality of times with deionized water. The actual etching of the pane takes place preferably with a solution of H₂SiF₆ and (SiO₂)m*nH₂O. The concentration of colloidally dissolved (SiO₂)m*nH₂O is preferably as much as 3 mmol above the (SiO₂)m*nH₂O saturation concentration. A more detailed description in this regard is found in DE 822 714 B, the content of which is part of the present application.

The etched pane is preferably heated to 550° C. to 650° C.

The heated, etched pane is cooled, preferably within 50 s to 90 s. The cooling takes place preferably with a cold air jet.

The invention further includes a reflection-reduced pane produced in accordance with the method according to the invention. The pane comprises at least one pane body and at least one reflection-reduced pane surface.

The surface of the pane has preferably a transmission (as energy transmission according to DIN-EN 410:1998) of >80%, preferably of >90%.

The surface of the pane has preferably a refractive index of 1.20 to 1.45, particularly preferably of 1.25 to 1.40.

The layer thickness of the surface of the pane is preferably 10 nm to 1000 nm, particularly preferably 50 nm to 200 nm.

The surface of the pane contains HF, H₂SiF₆, (SiO₂)ₘ*nH₂O, HCl, H₂SO₄, H₃PO₄, HNO₃, CF₃COOH, CCl₃COOH, HCOOH, CH₃COOH, NaOH, KOH, Ca(OH)₂, and/or mixtures thereof.

The body of the pane has preferably a transmission of >80%, preferably of >90%.

The body of the pane has preferably an area of >0.5 m², preferably of >5 m², and particularly preferably of >19 m².

The invention further includes the use of the pane according to the invention as a reflection-reduced pane.

The pane according to the invention is used preferably as building glass, motor vehicle glazing, and/or photovoltaic glazing.

In the following, the invention is explained in detail with reference to a drawing and one embodiment as well as one comparative example. The drawing is a purely schematic depiction and is not true to scale. It is no way restricts the invention.

An exemplary embodiment of the invention is depicted in the drawing and is described in detail in the following.

The figures depict:

FIG. 1 a cross-section of the reflection-reduced pane (3) according to the invention,

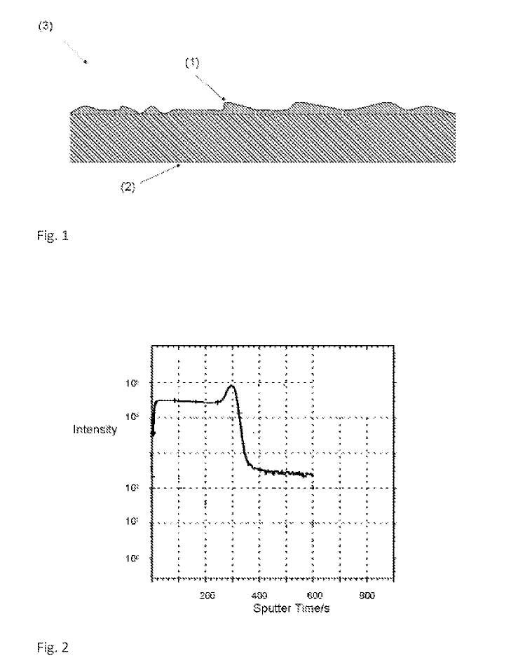

FIG. 2 a time-of-flight secondary ion mass spectrum (ToF-SIMS) (Cs₂F+/fluorine) of the surface of the pane (1) of a pane (3) according to the invention,

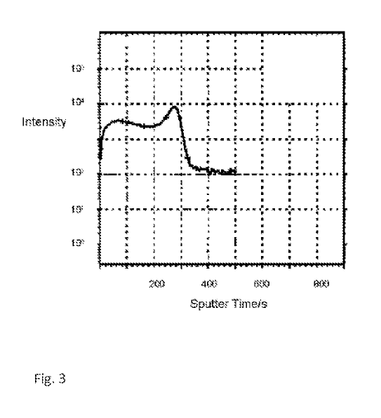

FIG. 3 a time-of-flight secondary ion mass spectrum (ToF-SIMS) (Cs₂F+/fluorine) of the surface of the pane (1) of a comparative pane (3).

FIG. 1 depicts a cross-section of the reflection-reduced pane (3) according to the invention. This pane includes a transparent pane body (2) and a reflection-reduced pane surface (1).

FIG. 2 depicts a time-of-flight secondary ion mass spectrum (ToF-SIMS) of the pane surface (1) of a pane (3) according to the invention (Example 1). The fluorine bound as Cs₂F⁻ in the pane surface (1) was detected. The maximum of the relative intensity in the range of the pane surface from 0 nm to 150 nm in the case of a pane (3) according to the invention is preferably higher by at least a factor of 5 than in the case of an (otherwise identical) tempered and subsequently etched pane (FIG. 3). The pane surface (1) is removed with the time (sputter time in s) and the ions released are detected.

FIG. 3 depicts a time-of-flight secondary ion mass spectrum (ToF-SIMS) of the pane surface (1) of a control pane (Comparative Example 2). The fluorine bound as Cs₂F⁺ in the pane surface (1) was detected. The experimental conditions are the same as in FIG. 2.

The reference characters signify:

(1) Pane surface,

(2) Pane body,

(3) Pane.

In the following, the invention is explained in detail with reference to an example of the method according to the invention and a comparative example.

In two series of experiments, the relative fluorine concentration of the pane surface (1) of a pane according to the invention (Example 1) and a control pane (Comparative Example 2) made of soda lime glass was compared. In the context of the invention, the expression “relative fluorine concentration” refers to the intensity of the Cs₂F⁺ signal in the ToF-SIMS experiment. Based on the signal intensities, it is possible to make a statement concerning the relative concentration ratio of fluorine in the pane surface (1) of the pane (3) according to the invention (Example 1) and the control pane (3) (Comparative Example 2).

### a) Example 1 (According to the Invention)

The pane was pre-etched with an HF solution (2 wt.-%), washed with deionized water, and etched with H₂SiF₆ (1.2 mol/L) for 30 min to 120 min in an immersion bath. The pane was then washed with deionized water and dried. In a second step, the pane was heated to 600° C. and cooled within 70 s in the cold air jet (tempering).

For the subsequent analysis and detection of the Cs²F⁺ signal, an IONTOF “TOF.SIMS 5” of the company ION-TOF (Tascon) GmbH (48149 Münster, Germany) was used. For the sputtering, a 1-keV Cs⁺ ion beam, a current of 100 nA was used on a sample area of 300×300 μm². The analysis was carried out with a 25-keV Bi₃⁺ ion beam and a current of 0.5 pA on an area of 100×100 μm². The polarity was positive. The resulting spectrum is depicted in FIG. 2.

### b) Comparative Example 2

The control pane (3 differs from the Example 1 according to the invention in that the control pane was tempered at approx., 600° C. before etching and was cooled within approx. 70 s in the cold air jet. The etching was then carried out under the same conditions as is in Example 1.

For the subsequent analysis and detection of the Cs₂F⁺ signal, an IONTOF “TOF.SIMS 5” of the company ION-TOF (Tascon) GmbH (48149 Münster, Germany) was used. For the sputtering, a 1-keV Cs⁺ ion beam, a. current of 100 nA was used on a sample area of 300×300 μm². The analysis was carried out with a 25-keV Bi₃⁺ ion beam and a. current of 0.5 pA on an area of 100×100 μm². The polarity was positive. The resulting spectrum can be seen in FIG. 3.

A comparison of the maxima of the relative intensities of Example 1 according to the invention and of the Comparative Example 2 is found in Table 1.

TABLE 1
Comparison of the relative intensity maxima
of fluorine as Cs₂F⁺ of Example 1 according
to the invention and of Comparative Example 2

| Example | Relative Intensity (Maxima) |
|---|---|
| Example 1 | 10⁵ |
| Comparative Example 2 | 10⁴ |

Table 1 indicates a signal intensity for fluorine in Example 1 according to the invention that is higher by a factor of 10 than in the Comparative Example 2. Thus, a. higher proportion of fluorine is bound by the etching process on the pane surface (1) of a pane (3) produced in accordance with the method according to the invention (Example 1), than with a control pane (3) produced according to the prior art (Comparative Example 2) from the same basic material.

1. A method of manufacturing a reflection-reduced pane, comprising:
a. etching a pane;
b. heating the etched pane to a temperature of 500° C. to 800° C.; and
c. cooling the heated, etched pane to a temperature of 25° C. to 70° C. within 30 seconds to 150 seconds with a cold air jet.

2. The method according to claim 1, wherein the etching further comprises applying and/or spraying a solution of acid and/or base on a surface of the pane.

3. The method according to claim 1, wherein the etching further comprises dipping the pane into a solution of an acid and/or base.

4. The method according to claim 1, wherein the etching the pane is performed with a solution selected from the group consisting of: HF, H₂SiF₆, (SiO₂)ₘ*nH₂O, HCl, H₂SO₄, H₃PO₄, HNO₃, CF₃COOH, CCl₃COOH, HCOOH, CH₃COOH, NaOH, KOH, Ca(OH)₂, and/or mixtures thereof.

5. The method according to claim 1, wherein the heating the etched pane is heated to a temperature of 550° C. to 650° C.

6. The method according to claim 1, wherein the cooling the heated, etched pane is performed within 50 seconds to 90 seconds.

7. A pane manufactured according to the method of claim 1, the pane comprising a pane body having at least one pane surface.

8. The pane according to claim 7, wherein the at least one pane surface has a transmission capacity of at least 80%.

9. The pane according to claim 7, wherein the at least one pane surface has a refractive index of 1.20 to 1.45.

10. The pane according to claim 7, wherein a layer thickness of the at least one pane surface is 10 nm to 1000 nm.

11. The pane according to claim 7, wherein the at least one pane surface comprises a solution selected from the group consisting of: HF, H₂SiF₆, (SiO₂)ₘ*nH₂O, HCl, H₂SO₄, H₃PO₄, HNO₃, CF₃COOH, CCl₃COOH, HCOOH, CH₃COOH, NaOH, KOH, Ca(OH)₂, and/or mixtures thereof.

12. The pane according to claim 7, wherein the pane body has a transmission capacity of at least 80%.

13. The pane according to claim 7, wherein the pane body has an area selected from the group consisting of at least 0.5 m², at least 5 m², and at least 19 m².

14. A method of using the pane of claim 7, the method comprising using the pane as a reflection-reducing pane.

15. The method according to claim 14, further comprising using the reflection-reducing pane as, selected from the group consisting of: a building glass, a motor vehicle glazing, and a photovoltaic glazing.

16. The pane according to claim 7, wherein the at least one pane surface has a transmission capacity of at least 90%.

17. The pane according to claim 7, wherein the at least one pane surface has a refractive index of 1.25 to 1.40.

18. The pane according to claim 7, wherein a layer thickness of the at least one pane surface is 50 nm to 200 nm.

19. The pane according to claim 7, wherein the pane body has a transmission capacity of at least 90%.
